(19) United States
(12) Patent Application Publication
(10) Pub. No.: US 2008/0196594 A1
(43) Pub. Date: Aug. 21, 2008

(54) Doner Kebab Slicing Robot

(76) Inventors: Musa Koseomur, New South Wales (AU); Erdem Koseomur, New South Wales (AU)

Correspondence Address: BROOKS KUSHMAN P.C., 1000 TOWN CENTER, TWENTY-SECOND FLOOR, SOUTHFIELD, MI, 48075, US

(21) Appl. No.: 11/914,774

(22) PCT Filed: Jul. 22, 2005
(86) PCT No.: PCT/AU05/01062

§ 371 Date: Nov. 19, 2007

(30) Foreign Application Priority Data
May 18, 2005 (AU) 2005902533

(51) Int. Cl. A47J 17/18; A47J 43/18; A47J 43/25; A47J 44/02

(52) U.S. Cl. 99/325; 99/357; 99/353

(57) ABSTRACT

The Doner Kebab Slicing Robot comprises of two linear slide assemblies preferably made of metal. The linear slides consist of track plate and wheel plate components. The vertical slide assembly contains a blade head (5) with a circular slicing blade (13) powered by a detachable motor (4). The vertical slide assembly is designed to be detachable from the horizontal slide assembly to allow for removal for daily cleaning. A rigid metal plate (22) which is the main base of the Doner Kebab Slicing Robot contains the horizontal slide assembly and is fixed to the top of the kebab rotisserie (29). The motor and drive assembly (25) for the rotation of the doper kebab is also contained within this main base plate. The slicing blade head runs on a wheel plate (3) which provides a vertical axis travel to the slicing blade head. The vertical motion of the said wheel plate is by a motor driven pulley (14) and wire belt (15) assembly or similar method driven by the motor (24) located on the wheel plate carriage (19) of the horizontal track (18) and the pulley (14) is located on the detachable vertical track plate (1). The vertical axis travel of the slicing blade head is a means for slicing the doper kebab meat in a downward direction and for returning the blade head back up to the top position to repeat the slicing procedure. A positioning guide (10) attached to the vertical slide track (1), functions as a sensor to designate the correct positioning of the slicing blade head (5) as it approaches the cooked done meat surface. The positioning guide (10) is in the form of a blade made of stainless steel. It is parallel to and approximately in the length of the vertical slide.

This invention relates to an automated robotic system for slicing of cooked doner kebab, chicken kebab or similar meat prepared and cooked on a conventional vertical kebab rotisserie without any human intervention.

Doner Kebab is a fast food or a restaurant type of food. It's a spicy meat that is prepared in a cylindrical form onto a steel rod. The rod runs through the vertical axis of the cylindrical form of meat. The prepared meat is loaded onto a vertical kebab rotisserie by the steel rod which is motor driven on the top or bottom of the kebab rotisserie. The meat slowly rotates about its axis as it cooks in front of a set of vertically stacked burners of the kebab rotisserie.

Until today Doner kebab has always been sliced manually by hand using slicing knives. The Doner kebab Robot is designed as an additional attachment to an existing doner kebab rotisserie and this invention is intended to eliminate the need for a service person to attend the doner kebab rotisserie for the purpose of slicing the cooked meat. The service person can continue serving the waiting customers while the robot constantly provides ready to serve sliced strips of meat inside the doner kebab rotisserie tray where the meat is ready for collection.

Prior to this invention, service persons were exposed to tremendous heat generated by the kebab rotisserie while manually slicing the kebab meat by hand. This caused extreme discomfort to the service person and also caused unpleasant, sweaty appearance in view of the customers waiting to be served at retail take away food outlets. This robotic system has overcome the disadvantages of manually slicing the doner kebab meat. The Doner Kebab Robot provides smoother, faster food service operation and health regulation advantages.

The Doner Kebab Slicing Robot has been designed not to occupy any service bench space. With hygiene and health regulations as a guide, food safe materials and technology are used.

The robot is positioned adjacent and parallel to the doner kebab rotisserie. The slicing of the meat is performed whilst the doner kebab meat is loaded and cooked on the vertical doner kebab rotisserie.

The invention comprises of two motor driven linear slide assemblies preferably made of metal. The linear slides consist of track plate and wheel plate components. They provide vertical and horizontal motion to a circular blade encased within a blade head with a motor attached. This combination of motion technology is used to accomplish the slicing procedure of the doner kebab while it is loaded and cooked on a conventional kebab rotisserie.

To assist with understanding the invention, reference will now be made to the accompanying drawings where:

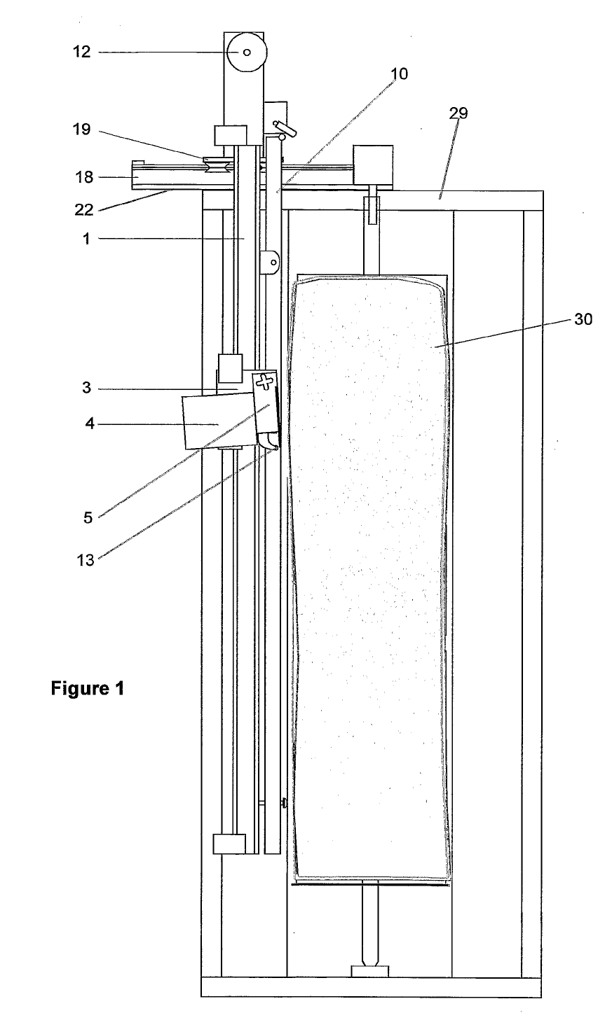

FIG. 1 is an elevation of the Doner Kebab Slicing Robot showing the mounted position when fitted to a conventional kebab rotisserie.

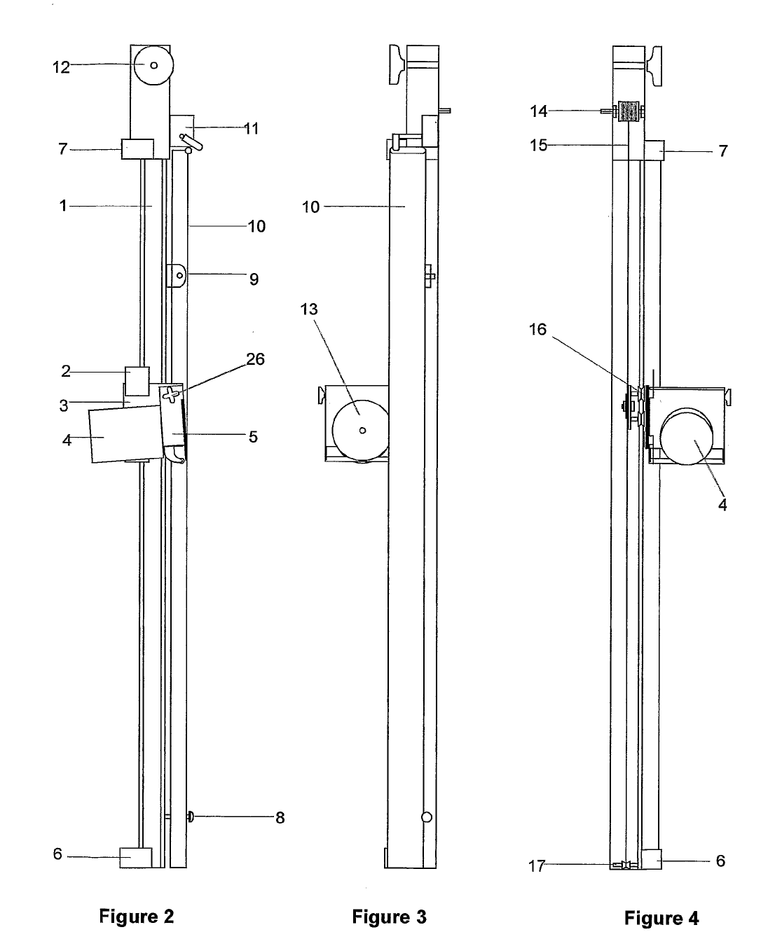

FIG. 2 shows the front view of the vertical linear slide assembly with the slicing motor attached and

FIGS. 3 and 4 are the right and left hand side views of the vertical linear slide assembly with the slicing motor attached

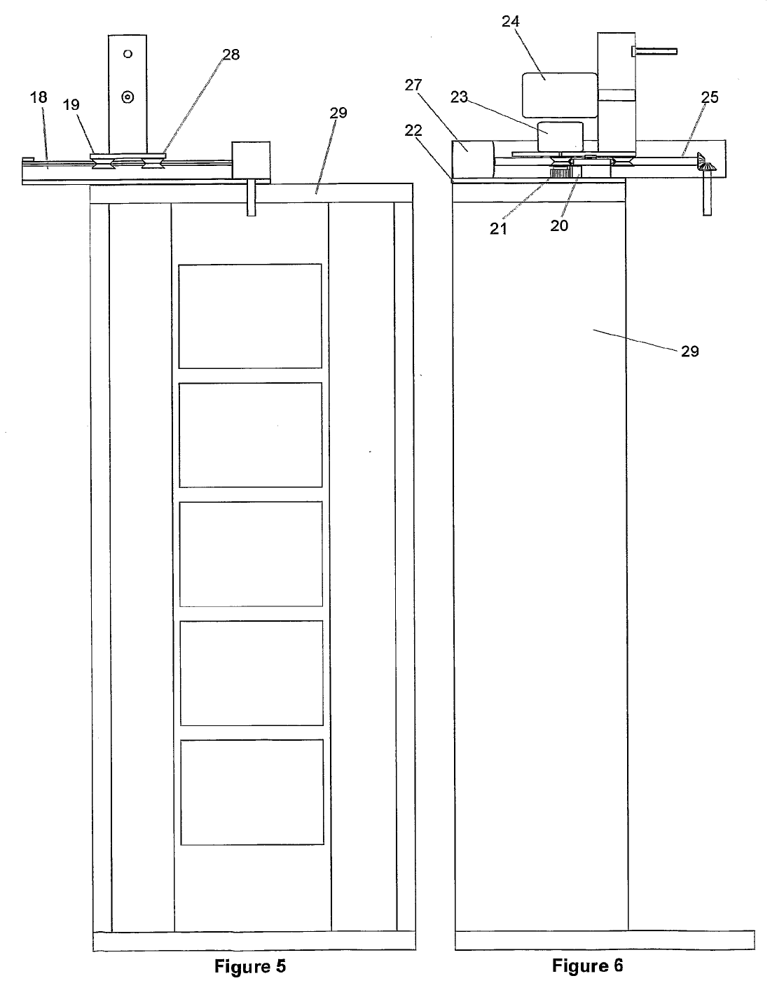

FIG. 5 shows the front view and FIG. 6 shows the left hand side view of the horizontal linear slide assembly with the vertical linear slide detached from it.

The vertical slide assembly contains a blade head (5) with a circular slicing blade (13) powered by a detachable motor (4). The vertical slide assembly is designed to be detachable from the horizontal slide assembly to allow for removal for daily cleaning. A rigid metal plate which is the main base plate (22) of the Doner Kebab Slicing Robot contains the horizontal track plate assembly and is fixed to the top of the kebab rotisserie (30). The motor and drive assembly (25) for the rotation of the doner kebab is also contained within this main base plate.

The vertical track (1) consists of a wheel plate carriage assembly (3) containing a blade head (5) which is attached to the said wheel plate by a bolt and threaded wing nut (26) to allow for removal for daily cleaning. The blade head (5) may be made of heat resistant plastic or aluminium. The circular blade (13) is positioned within the blade head 5. A positioning guide (10) made of metal is a means for designating the slicing position of the blade head (5) when its reaches the doner kebab meat (30).

The slicing blade head runs on a wheel plate (3) which provides a vertical axis travel to the slicing blade head. The vertical motion of the said wheel plate is by a motor driven pulley (14) and wire belt (15) assembly or similar method driven by the motor (24) located on the wheel plate carriage (19) of the horizontal track (18) and the pulley (14) is located on the detachable vertical track plate (1). The vertical axis travel of the slicing blade head is a means for slicing the doner kebab meat in a downward direction and for returning the blade head back up to the top position to repeat the slicing procedure.

The horizontal linear slide assembly is a means to move the blade toward and away from the slicing position point on the doner kebab surface. The vertical linear track (1) containing the slicing blade head (5) is perpendicularly attached to the horizontal linear slide at the top end via a carriage wheel plate (19) with a bolt and threaded handwheel (12) attachment to allow for removal for daily cleaning. Movement to the horizontal carriage wheel plate is applied by a motor driven spur gear (21) and rack (20) assembly.

1.-18. (canceled)

19. A Doner Kebab Slicing Robot comprising a horizontal and vertical linear track plate assemblies containing wheel plate assemblies to perform the slicing procedure by providing the slicing blade head with motion in the horizontal and vertical axis, the vertical track plate being detachable from the wheel plate of the horizontal track plate for daily cleaning, the said slicing blade head being mounted to and being detachable from the wheel plate of the said vertical track plate for cleaning, the positioning guide attached to and located on the said vertical track plate for the purpose of designating the slicing position of the slicing blade head in respect to the doner kebab meat cylinder, a rotary contact switch located on the upper section of the said vertical track plate that operates in conjunction with the positioning guide, the position of the motor being located on wheel plate of the horizontal track plate which drives the slicing blade head in the vertical axis and the method of transmission being a pulley and stainless steel wire belt assembly, the arrangement of a spur gear rack embedded within the said horizontal track plate where the said corresponding wheel plate is driven by a motor having a spur gear, the fractional and continuous rotation of the doner kebab meat via a motor and bevel gear drive assembly, control switch boxes located on the upper and lower end of the vertical linear track plate containing a contact switch and a hall effect vane switch that controls the operation of the Doner Kebab Slicing Robot.

20. A Doner Kebab Slicing Robot as claimed in claim 19 wherein the horizontal and vertical linear track plates are made of aluminum or s/s with tracks made of s/s and wheel plate carriages made of s/s or aluminum having s/s guide wheels which have V grooved profiles or similar profiled outer rings that fit the shape of the profiled edge of the linear tracks.

21. A Doner Kebab Slicing Robot wherein the main base plate is a rigid support platform that is positioned on top of a conventional doner kebab rotisserie containing the arrangement the horizontal track plate, the wheel plate assembly and the bevel gear drive assembly.

22. A Doner Kebab Slicing Robot as claimed in claim 19 wherein the motor driven bevel gear drive assembly is a means to provide a vertical axis rotation to the doner kebab meat while it cooks in front of the burners of the doner kebab rotisserie.

23. A Doner Kebab Slicing Robot as claimed in claim 21 wherein the motor driven bevel gear drive assembly is a means to provide a vertical axis rotation to the doner kebab meat while it cooks in front of the burners of the doner kebab rotisserie.

24. A Doner Kebab Slicing Robot as claimed in claim 21 wherein the horizontal track plate and wheel plate is a means to provide a horizontal axis motion to the slicing blade head so as to move the slicing blade head to the slicing position on the surface of the doner kebab meat and away from the surface of the doner kebab meat via the vertical track plate that is attached to the wheel plate which comprises a motor to propel the said wheel plate.

25. A Doner Kebab Slicing Robot as claimed in claim 22 wherein the method to provide a horizontal axis motion to the slicing blade head is by a metric rack contained within the horizontal track plate and a spur gear assembly driven by a motor located on the wheel plate this horizontal axis motion is a means to move the slicing blade head to the surface of the doner kebab meat so as to make the blade head in contact with the meat and to position the slicing blade head ready to perform the downward slicing motion in order to cut strips of cooked meat from the surface of the doner kebab meat cylinder.

26. A Doner Kebab Slicing Robot as claimed in claim 20 wherein the vertical track plate and corresponding wheel plate provide a means of vertical axis motion to the slicing blade head where the downward motion slices strips of meat from the surface of the doner kebab cylinder and the upward motion retrieves the blade head to repeat the slicing procedure of the meat.

27. A Doner Kebab Slicing Robot as claimed in claim 19 wherein the vertical track plate is designed to be detachable from the wheel plate by a hand wheel located at the upper section of the said track plate so as to allow for easy removal from the main base plate for the purpose of cleaning after daily use of the unit.

28. A Doner Kebab Slicing Robot as claimed in claim 27 wherein the vertical axis transmission to the blade head which is attached to the wheel plate is by a motor driven pulley and s/s wire belt assembly arrangement built in to the vertical track plate where the pulley is loaded with a certain length of wire belt and attached to the wheel plate so as to be able to transport the slicing blade head in the length of the vertical track plate for slicing the meat in a vertically downward direction, the corresponding pulley provides tension to the s/s wire belt.

29. A Doner Kebab Slicing Robot as claimed in claim 19 wherein the vertical track plate comprise two switch boxes each control switch box contains a hall effect vane switch combined with a contact switch within it self where the two switches work in conjunction with each other to monitor the position and motion of the slicing blade head during the slicing operation.

30. A Doner Kebab Slicing Robot as claimed in claim 20 wherein the vertical track plate comprise two switch boxes each control switch box contains a hall effect vane switch combined with a contact switch within it self where the two switches work in conjunction with each other to monitor the position and motion of the slicing blade head during the slicing operation.

31. A Doner Kebab Slicing Robot as claimed in claim 30 wherein the two control switch boxes located in the vertical track plate have an opening on the side that face each other so that the steel tabs located on the wheel plate carriage enters the opening of the switch boxes at either end of the linear track plate to initiate a command of operation for the slicing process of the Doner Kebab Robot such as to move the blade head in the horizontal and the vertical axis when in contact with the combined hall effect vane switch and contact switch which are inside the switch boxes.

32. A Doner Kebab Slicing Robot as claimed in claim 19 wherein the positioning guide is a rigid flat blade made of metal and approximately in the length of the vertical track plate so that as it approaches the cooking meat it makes contact with the body of the meat cylinder and activates the rotary switch to designate a suitable slicing position for the slicing blade head.

33. A Doner Kebab Slicing Robot as claimed in claim 19 wherein the positioning guide is attached to the vertical track plate by a spring-loaded pin and a pivot point which the positioning guide oscillates about to activate a rotary switch for the purpose of designating the correct stop position when the slicing blade head has reached the suitable slicing point on the surface of the doner kebab meat.

34. A Doner Kebab Slicing Robot as claimed in claim 33 where the rotary switch comprise a lever that is activated when the positioning guide oscillates about its pivot point when pressure is applied to it at the point of contact with the surface of the meat as the slicing blade head reaches the surface of the doner kebab while travelling in the horizontal axis thus establishing the slicing position for the slicing blade head to begin the downward slicing action.

35. A Doner Kebab Slicing Robot as claimed in claim 19 wherein the motor driven bevel gear drive assembly is controlled by the positioning guide while the system is engaged in the slicing process in that it provides a fractional rotation to the meat by controlling motor so that the meat is stationary while the downward slicing procedure of the slicing blade head takes place, the bevel gear dive assembly resumes rotation of the meat cylinder after a meat strip has been cut, the blade head is then retrieved back up to the top section on the vertical linear track by means of motor driven pulley and wire belt assembly that provides the vertical axis travel to the blade head via the track plate and corresponding wheel plate to repeat the downward slicing action again.

36. A Doner Kebab Slicing Robot wherein the operation commands given to the Doner Kebab Slicing Robot are performed by a hand held remote controller where the user is able to command the system to start slicing the doner kebab meat with preset user adjustable cook timer that activates the slicing process of the system to begin slicing the doner kebab meat according to the set time interval, upon this command the downward slicing procedure in which the blade head cutting vertically sliced strips of meat is repeated until a full 360° rotation of the doner kebab meat has been established, the system then stops slicing which allows the meat to cook further for a user adjustable cook time where the meat cylinder slowly and continuously rotates about its axis before the blade head automatically performs the slicing procedure of the meat after the desired cook time set has lapsed.

37. A Doner Kebab Slicing Robot as claimed in claim 36 wherein the said system function to begin slicing the cooked meat after an adjustable cook time, can be set to manual activation so as to order the system to start slicing only on demand of the operating person according to meat service requirement.
